(19) United States
(12) Patent Application Publication
(10) Pub. No.: US 2013/0240224 A1
(43) Pub. Date: Sep. 19, 2013

(54) Process for Making a One-Piece Garden Tool

(71) Applicant: Craig A. Lick, Allendale, MI (US)

(72) Inventor: Craig A. Lick, Allendale, MI (US)

(21) Appl. No.: 13/423,232

(22) Filed: Mar. 18, 2012

(51) Int. Cl. A01B 1/22; B32B 37/06; B32B 37/26; B32B 38/00; A01B 1/00; A01B 1/02

(52) U.S. Cl. 172/371; 294/57; 156/308.2; 156/245; 156/73.5; 156/73.2

(57) ABSTRACT

A one-piece garden tool, and process for manufacturing a one-piece garden tool such as a shovel, in which the head of the garden tool and its rod are made from two pieces of plastic. The head further contains a joint portion into which the rod is inserted and axial force and rotational speed are applied with sufficient force to create friction that melts a layer of the rod and joint so the plastic of each mixes. The rod and head are then cooled, and the plastics merge into a single one-piece plastic garden tool. Alternately, ultrasonic waves may be used to melt the rod and joint layers.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates generally to the field of garden tools, and more particularly to a one-piece plastic shovel manufactured by coupling two plastic pieces together and melting them into a single unit.

2. Background Art

Garden tools are typically made in two pieces. They consist of an implement such as a shovel or rake head to which a rod is attached by a joint. The head is typically stamped metal, and the rod is either wood or some type of fiberglass resin material.

Tools with wooden handles are inexpensive to make, but are heavy and not very durable, particularly for shovels. The wood often breaks in two when substantial force is exerted against the shovel, and sometimes the joint where the wood and metal are secured fails. Tools with fiberglass rods are lighter, but more expensive, and may lack sufficient durability in the joint, such that it breaks when sufficient force is exerted on the shovel.

One design by Remco (www.remcoproducts.com) attempts to solve this problem by creating a one-piece plastic shovel. While this provides for a strong one-piece light-weight shovel with sufficient durability, it is very expensive to make because a large mold is required to make the entire shovel, or other garden tool.

It would be advantageous to make a one-piece garden tool that does not require a large single mold, thereby substantially reducing the cost of manufacturing and in turn the retail sales price of the garden tool.

An additional problem with shovel designs is that the user's foot sometimes slips off the top of the shovel head when the user applies significant force against the shovel when pushing it into the ground. This frustrates the user and sometimes results in injury if the person's leg hits the shovel top with substantial force. It would be advantageous to create means to prevent or substantially limit one's foot from sliding off the shovel head when significant force is applied.

### BRIEF SUMMARY OF THE INVENTION

The present invention solves these problems by creating a smaller plastic mold for the garden tool head with a male joint in line with the tip of the shovel blade or the center of the garden tool on the operative edge. A plastic rod of the same plastic material may be manufactured using a standard extrusion machine, into which the male joint of the plastic head of the shovel or garden tool is inserted. Axial and rotational force is then applied to the rod or shovel head such that the friction causes the plastic in the joint region to melt, thereby bonding the rod and joint of the garden tool into a single plastic unit as it cools. This solves the problems of conventional two-piece designs by creating a durable light-weight garden tool made of strong plastic, without the excessive cost of a large one-piece mold.

Alternately, an ultrasonic method may be employed to melt the plastic in the joint region instead of applying axial and rotational force to the rod and joint. Ultrasonic waves of sufficient amplitude, frequency and duration are directed toward the joint region to heat the plastic to melt such that it may later cool into a single integral unit.

It is another object of the present invention to create a shovel head that yields a shovel having ridges on the top side of the shovel where the user's foot is applied when pushing the shovel into the ground. The outer sides of the shovel head also has extensions that prevent the user's foot from sliding off the side of the shovel head.

### BRIEF DESCRIPTION OF THE SEVERAL VIEWS OF THE DRAWINGS

The accompanying drawings illustrate the invention, where like reference numerals indicate the same feature throughout the drawings:

FIG. 1 shows a 3-dimensional view of a finished shovel in accordance with the preferred embodiment of the present invention;

FIG. 2(a) shows a 3-dimensional view of a mold for forming the shovel head shown in FIG. 1;

FIG. 2(b) shows a 3-dimensional view of an extrusion machine ejecting the rod of the shovel in the preferred embodiment of the present invention;

FIG. 2(c) shows a 3-dimensional view of the shovel head about to be inserted onto the rod shown in the preferred embodiment of the present invention;

FIG. 2(d) shows an alternate embodiment of the present invention in which ultrasonic waves are used to melt the joint between the shovel head and rod;

FIG. 3(a) shows an enlarged cross-sectional view of the joint between the rod and shovel head onto which the rod is inserted and rotated in the preferred embodiment of the present invention;

FIG. 3(b) is a cross-sectional view enlargement of the joint between the rod and shovel shown in FIG. 3(a) with a thin layer of plastic on each melted when axial force and rotational speed have been applied between the two portions;

FIG. 4(a) shows a plane view the shovel head of FIG. 1 having ridges and side extensions; and

FIG. 4(b) shows an enlargement of the plane view of FIG. 4(a), showing the geometry and relative heights of the ridges and side extension of the preferred embodiment of the present invention.

### DETAILED DESCRIPTION OF THE INVENTION

The drawings are for illustrative purposes of the preferred embodiment of the present invention, shown for a shovel. The same design characteristics apply to other garden tools and similar implements, as would be obvious to one ordinarily skilled in the art.

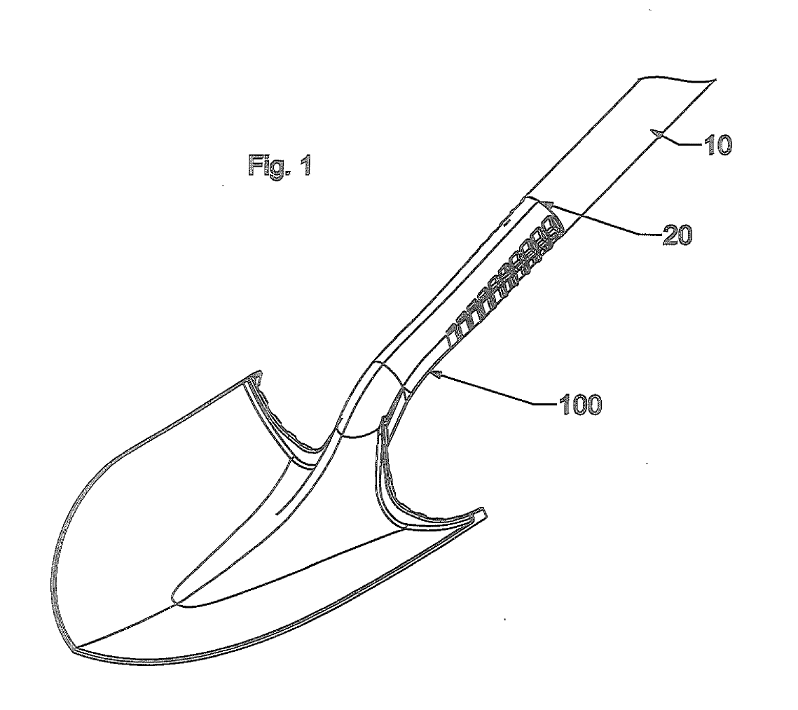

FIG. 1 shows the completed one-piece shovel, including rod 10 which is attached to shovel head 100 via joint 20. It is preferably comprised of a hard, rigid thermoplastic that is capable of melting at high temperatures and reforming when cooled. Many such thermoplastics may be used, although the preferred embodiment employs nylon or polypropylene material.

In the completed one-piece shovel, joint 20 and rod 10 become a single unit after a layer of thermoplastic on the adjacent surfaces melt and reform upon cooling. This process shall be explained in further detail below.

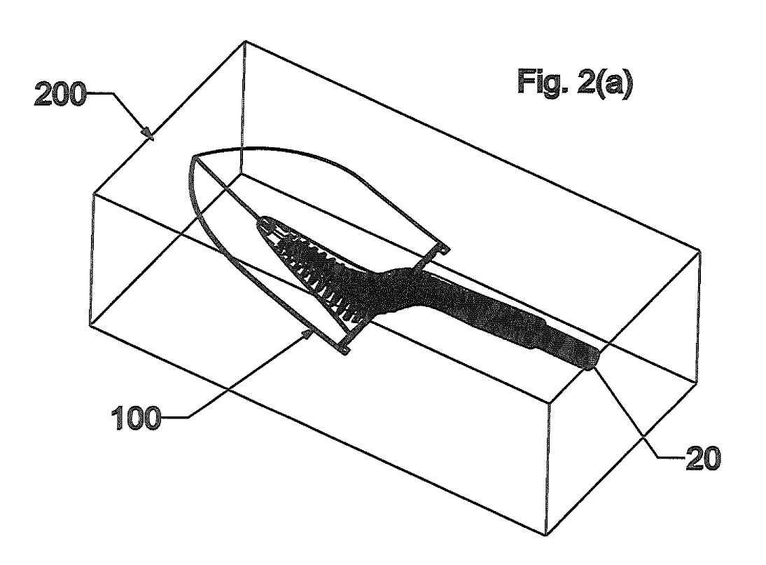

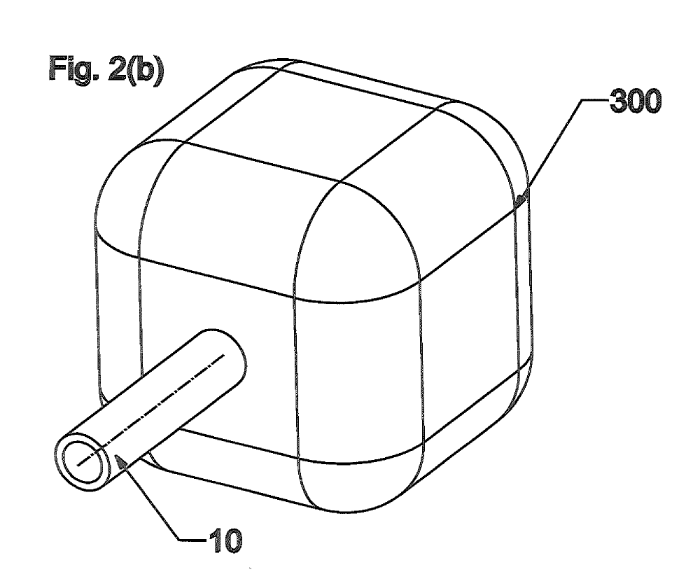

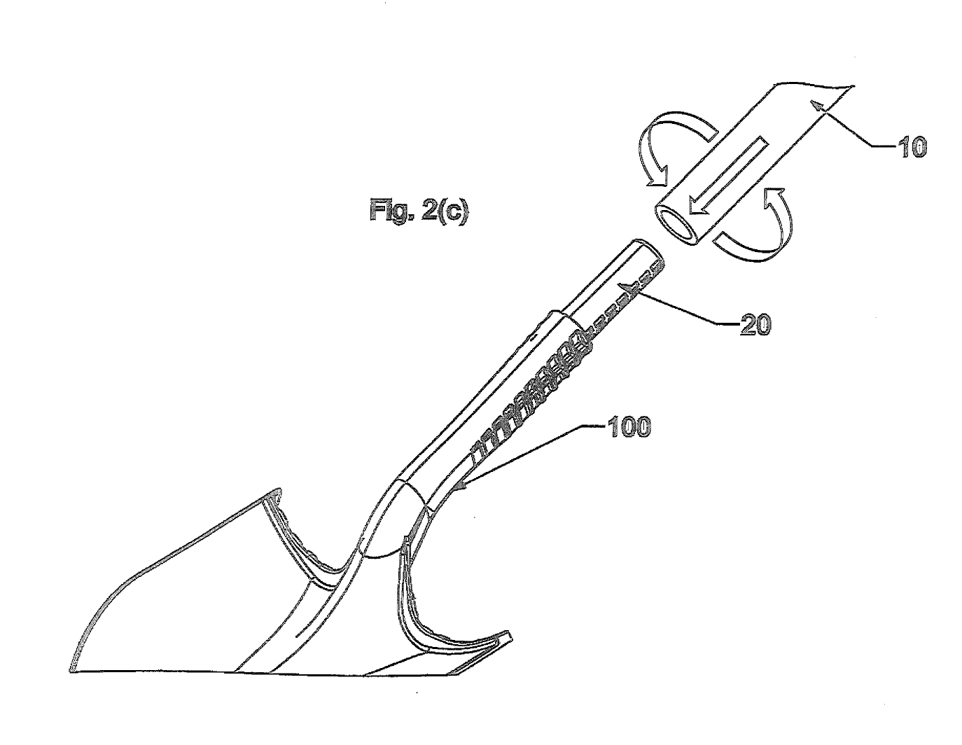

FIG. 2(a) shows mold 200 in which shovel head 100 is fabricated. Note that shovel head 100 includes joint 20. Those skilled in the art will appreciate that any standard mold and process for using the mold may be used.

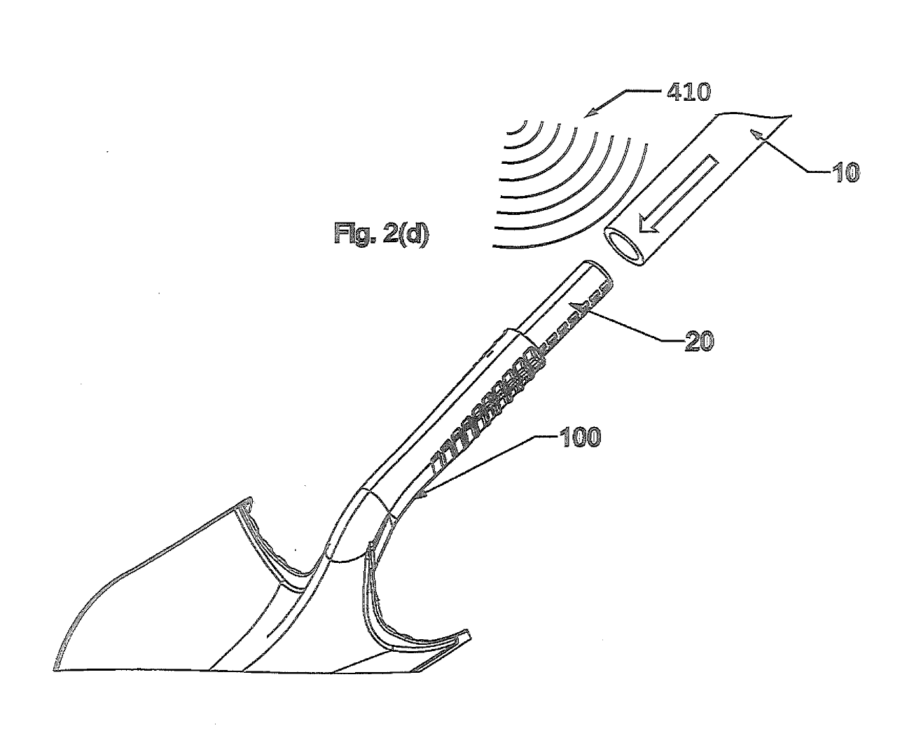

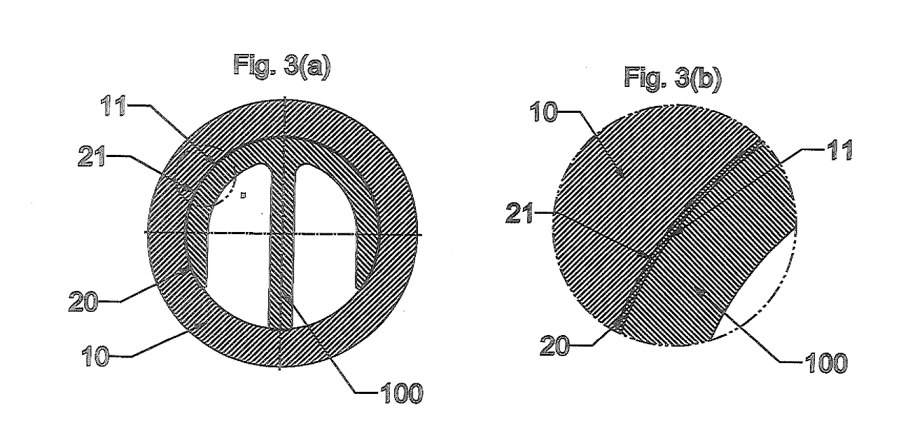

FIG. 2(b) shows extraction machine 300 that produces rod 10, which is cylindrical and of the desired diameter and length. Rod 10 preferably comprises a hollow tube, as shown in FIG. 3(a). The crux of the present invention is inserting joint 20 into rod 10—as shown in FIG. 2(c) and FIG. 3(a)—and applying sufficient axial force and rotational speed to produce friction that melts a layer of plastic on the internal periphery of rod 10 and the external periphery of joint 20, as shown in FIG. 3(b). When the axial and rotational force is terminated after a sufficient time period, the plastic cools, forming a solid connection between rod 10 and joint 20 such that the plastic becomes one uniform piece from the tip of shovel head 100 to the end of rod 10 opposite shovel head 100, as shown in FIG. 1. This yields a one-piece construction that is durable, light weight and relatively inexpensive to manufacture.

A customized machine—not shown in the drawings—is employed to produce the axial force and rotational speed required to produce the necessary friction to melt the layer of plastic on rod 10 and joint 20. Such a machine would be obvious to those skilled in the art. FIG. 3(b) shows an enlargement of FIG. 3(a) after joint 20 is inserted into rod 10 and axial force and rotational speed employed. Either shovel head 100 or rod 10 may be rotated, or both, an axial force may also be applied to either or both shovel head 100 and rod 10.

The rotational speed and axial force causes rod layer 11 and joint layer 21 of rod 10 and joint 20, respectively, to melt during this process, and the melted plastic of rod layer 11 and joint layer 21 mix such that when cooled, they form a continuous integral piece of plastic.

An alternate embodiment of the present invention is shown in FIG. 2(d), in which ultrasonic waves are directed towards the area in which rod 10 touches joint 20. An ultrasonic device (not shown) directs ultrasonic waves 410 towards rod 10 and joint 20 after joint 20 is inserted into rod 10. Ultrasonic waves 410 should be of sufficient amplitude, frequency and duration to melt the layers of rod 10 and joint 20 to allow them to cool into a single integral piece just as shown in FIGS. 3(a) and 3(b) and as described above.

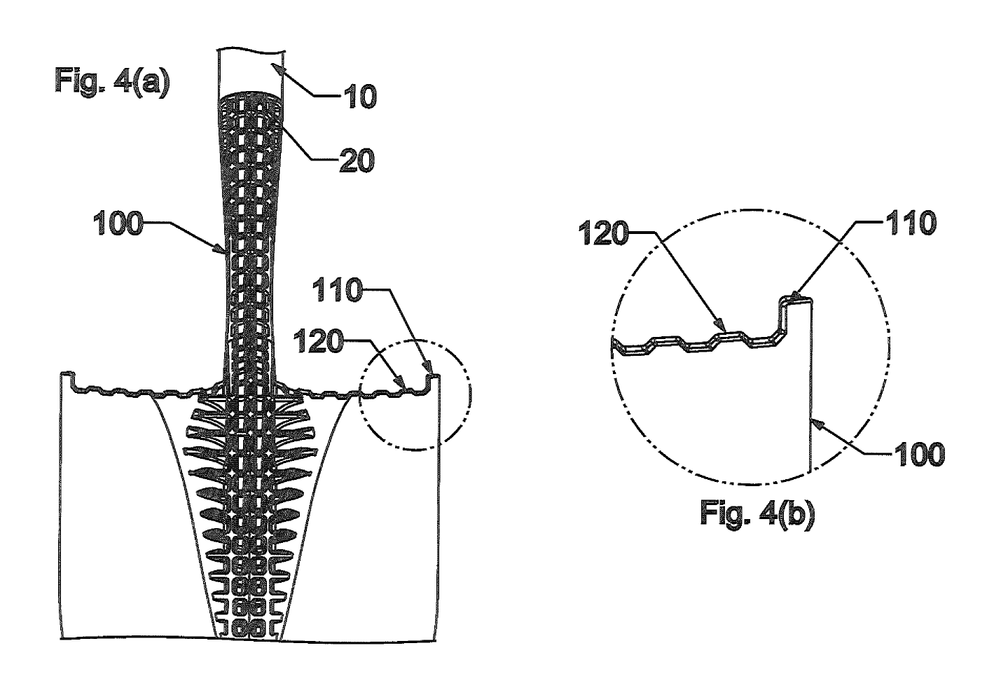

Another feature of the present invention, shown in FIG. 4, is a construction of shovel head 100 that has ridges 120 on the top portion, opposite the tip of shovel head 100. Ridges 120 are designed to provide better traction between a user's shoe or boot and shovel head 100 to substantially reduce slippage during use. Extensions 110 extend upwards from shovel head 100 to form a barrier to prevent the user's show or boot from slipping sideways off ridge 120. As shown in FIG. 4, extensions 110 extend outward from the top edge of shovel head 100 in a generally parallel direction relative to rod 10.

While the various drawings depict a shovel, those skilled in the art will appreciate that many different garden tool heads (and other implements) may be inserted into rod 10 with different designs than shovel head 100. For example, shovel head 100 may be replaced by a rake, or a snow shovel. Additionally, other shovel head geometries may replace the shape shown in the various drawings for shovels having different primary functions. And if an ultrasonic method is used to melt and meld rod 10 to joint 20 into a single integral piece, other geometries of the rod and joint other than cylindrical may be employed.

In the preferred embodiment, the periphery of rod 10 and joint 20 are smooth; however, those skilled in the art will understand that each may contain slight ridges or grooves.

Various other modifications may be made to that depicted in the various drawings of the preferred embodiment of the present invention without departing from the spirit and scope of the invention. Accordingly, the invention is not to be limited by the preferred embodiment shown in the various drawings and described herein, but by the scope of the claims.

1. A process for making a garden tool comprising the steps of:
creating a rod substantially made of plastic;
creating a head substantially made of plastic having a joint on one end of the head;
connecting the rod to the joint such that the rod and the joint are in substantial contact with each other;
melting a layer of the rod that is in contact with the joint, and melting a layer of the joint that is in contact with the rod; and
allowing for the rod and joint to cool such that the melted layers of the rod and the joint solidify into one integral unit.

2. The process for making a garden tool of claim 1 in which the rod and head are made from a thermoplastic material.

3. The process for making a garden tool of claim 2 in which the rod is made by an extraction machine.

4. The process for making a garden tool of claim 2 in which the head is a shovel made in a mold.

5. The process for making a garden tool of claim 4 in which a top edge of the head adjacent to the rod comprises ridges.

6. The process for making a garden tool of claim 5 in which an outer portion of the top edge of the head adjacent to and opposite the rod comprises an extension portion extending generally parallel to the rod.

7. The process for making a garden tool of claim 1 in which the step of melting a layer of the rod that is in contact with the joint, and melting a layer of the joint that is in contact with the rod, comprises applying axial force and rotational speed between the rod and joint for a period of time sufficient to generate friction that melts the layer of the rod and the layer of the joint.

8. The process for making a garden tool of claim 1 in which the step of melting a layer of the rod that is in contact with the joint, and melting a layer of the joint that is in contact with the rod, comprises applying ultrasonic waves to the general area between the rod and the joint of sufficient amplitude, frequency and duration to melt the layer of the rod and the layer of the joint.

9. A garden tool made by a process comprising the steps of:
creating a rod substantially made of thermoplastic material;
creating a head substantially made of thermoplastic material having a joint on one end of the head;
placing the rod and joint against each other such that one is inserted into the other;
melting a layer of the rod and a layer of the joint that are in contact with each other; and
allowing the rod and the joint to cool such that the melted layers of the rod and the joint solidify into one integral unit.

10. The garden tool of claim 9 in which the step of melting a layer of the rod and a layer of the joint that are in contact with each other comprises applying axial force and rotational speed between the rod and the joint for a period of time sufficient to generate friction that melts the layer of the rod and the layer of the joint.

11. The garden tool of claim 9 in which the step of melting a layer of the rod and a layer of the joint that are in contact with each other comprises applying ultrasonic waves directed towards the rod and joint of a frequency, amplitude and duration sufficient to melt the layer of the joint and the layer of the rod.

12. The garden tool of claim 10 in which the head is a shovel made in a mold.

13. The garden tool of claim 12 in which the shovel further includes ridges on a top edge of the head adjacent to the rod.

14. The garden tool of claim 13 in which the shovel further includes extensions of outer ends of the top edge of the head opposite the rod that extend outward generally parallel to the rod.

15. A shovel comprising:
a rod; and
a head having a top edge adjacent to the rod;
wherein the top edge has ridges to reduce the chances that a user's foot slides off the top edge of the head.

16. The shovel of claim 15 in which the shovel is a one-piece construction.

17. The shovel of claim 16 in which the shovel is made of thermoplastic material.

18. The shovel of claim 15 in which the top edge further comprises extensions opposite the rod and that extend in a direction generally parallel to the rod.

19. The shovel of claim 18 in which the shovel is a one-piece construction.

20. The shovel of claim 19 in which the shovel is made of thermoplastic material.
